(19) United States
(12) Patent Application Publication
(10) Pub. No.: US 2005/0144054 A1
(43) Pub. Date: Jun. 30, 2005

(54) Method and apparatus for manual resource assignment

(76) Inventors: Oliver Rueckert, Walldorf (DE); Thomas Schumacher, Heidelberg (DE)

Correspondence Address: KENYON & KENYON, 1500 K STREET, N.W., SUITE 700, WASHINGTON, DC, 20005, US

(21) Appl. No.: 10/747,140

(22) Filed: Dec. 30, 2003

(51) Int. Cl. G06F 17/60

(52) U.S. Cl. 705/8

(57) ABSTRACT

Embodiments of the present invention provide a manual resource assignment system. In one embodiment, manual modifications to a requirement element are received. A search for one or more receipt elements may be conducted based on the manually modified requirement element. A list of one or more receipt elements may be generated based on the search. A selection of the one or more receipt elements may be received. A dialog to manually generate an off-cut portion from the receipt element may be presented. An output order may be generated. The output order may be generated by deducting the off-cut portion from the selected one or more receipt elements. An off-cut order may be generated to submit the off-cut portion to production stock.

### BACKGROUND OF THE INVENTION

The present invention relates to a method and apparatus for managing customer orders. In particular, the present invention relates to a method and apparatus for manual resource assignment.

Many companies use planning and/or scheduling systems to process customer orders for goods and/or services. Manufacturers may often rely on such systems to manage and integrate business processes to complete customer requests. Companies that supply metal products, forest products, textiles and building materials have to schedule and manage customer orders or other demands, product production and delivery in a timely manner. These industries are faced with peculiar supply chain management challenges as they produce complex products with various product, dimension, quality, and process attributes. Companies which provide such products and/or services are straining to improve customer relationships and services to keep competitiveness and customer loyalty.

Conventional ordering systems do not provide a manual resource assignment dialog if the ordering system is unable to assign product quantities to automatically fill the customer's order. Therefore, it is desirable to have an ordering system that permits manual modification of the requirement element or demand so that resources are allocated efficiently, and inventory, storage, waste and/or administration costs are minimized.

### BRIEF DESCRIPTION OF THE DRAWINGS

FIG. 1 is a block diagram illustrating a manual resource assignment system in accordance with embodiments of the present invention.

FIG. 2 is a block diagram of a manual resource assignment device in accordance with an embodiment of the present invention.

FIG. 3 is a screen snapshot of a computer display in accordance with an embodiment of the invention.

FIG. 4 is a screen snapshot of a computer display in accordance with an embodiment of the invention.

FIG. 5 is a screen snapshot of a computer display in accordance with an embodiment of the invention.

FIG. 6 is a screen snapshot of a computer display in accordance with an embodiment of the invention.

FIG. 7 is a screen snapshot of a computer display in accordance with an embodiment of the invention.

FIG. 8 is a screen snapshot of a computer display in accordance with an embodiment of the invention.

FIG. 9 is a screen snapshot of a computer display in accordance with an embodiment of the invention.

FIG. 10 is a screen snapshot of a computer display in accordance with an embodiment of the invention.

FIG. 11 is a screen snapshot of a computer display in accordance with an embodiment of the invention.

FIG. 12 is a screen snapshot of a computer display in accordance with an embodiment of the invention.

FIG. 13 is a flowchart illustrating a method in accordance with an embodiment of the present invention.

### DETAILED DESCRIPTION

Embodiments of the present invention relate to a manual resource assignment (MRA) system, method and apparatus.

In embodiments of the present invention, MRA enables efficient ordering, use, processing and/or delivery of products to customers or any other entity. For example, when processing a requirement or demand, the MRA system may perform a search for the requirement element in existing inventory, pending purchase orders, planned production orders, etc. If a receipt element to complete or cover the requirement is not found, an MRA interface may be presented to the user. In an embodiment of the present invention, MRA may permit manual intervention by the user so that modifications to the requirement element can be made. If the user makes manual modifications to the requirement element, the modified requirement element may be used to search for receipt elements. Additional searches may be performed to identify receipt elements to complete the requirement. The user may continue to make modifications to the requirement until the desired receipt element or elements are identified.

In embodiments of the present invention, off-cuts may be generated from the receipt elements. These off-cuts may be used for stock, planned production orders, purchase orders, etc. In embodiments of the present invention, the user can search for, identify and/or select product substitutes if the exact order cannot be fulfilled. The MRA system may permit the user to select substitute products that most efficiently utilize resources and/or effectively complete the customer's order.

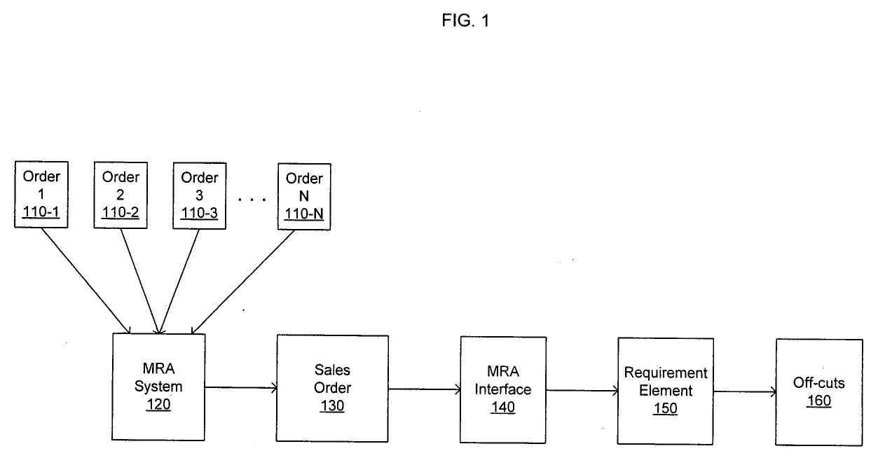

FIG. 1 is a block diagram illustrating how requirements or demands may be processed in accordance with embodiments of the present invention. As shown in FIG. 1, orders 110-1 to 110-N may be received at a manual resource assignment (MRA) system 120. The MRA system 120 may provide a sales order interface 130. The user may use the sales order interface to input information related to the requirement elements identified by the orders 110-1 to 110-N. The information may include product criteria (input elements) such as product identification, description and/or other characteristics associated with the desired product. For example, such information may identify the product as well as include the quantity, quality and/or other information associated with the desired product or requirement. Other information associated with the requirement elements may include delivery dates and/or delivery times that indicate when the product and/or services may be required by the customer. As one or more orders 110-1 to 110-N are received, they may be input and processed by the MRA system 120 and/or the sales order interface 130, in accordance with embodiments of the present invention.

In embodiments of the present invention, the MRA system 120 may identify one or more receipt elements that may be used to cover the requirements of the orders (requirement order). A “receipt element” may be defined as an element of an order that represents the availability date and the quantity of a product that is provided by the order. Receipt elements may be items in stock, items planned for production, items purchased from a third party and/or any other item that may be used to complete the sales order or the customer's order.

In embodiments of the present invention, a MRA interface 140 may be presented to the user. The MRA interface 140 may present the identified receipt elements that match the requirement element. If an exact match can not be identified and/or if the user is unsatisfied with the identified receipt elements for any reason, the user may use the MRA interface 140 to manually modify the requirement element, in accordance with embodiments of the present invention. The MRA interface 140 may permit manual modification to the customer's order in accordance with embodiments of the present invention. The MRA system 120 may perform another search based on the modified requirement element and results may again be presented to the user via the MRA interface 140. If desired, the user may select one or more identified receipt elements and/or may continue to modify the requirement element so that additional receipt elements may be identified. After the user has identified one or more receipt elements to cover or complete the order, the identified receipt element order 150 and/or the off-cut order 160 may be generated.

The system shown in FIG. 1 may be used for order processing, production planning, detailed scheduling and manual resource assignment in accordance with embodiments of the present invention. It is recognized that the system and/or process shown in FIG. 1 and described above in accordance with embodiments of the present invention, may be implemented using appropriate computer systems which may include processor(s) storage device(s), I/O device(s), and/or other hardware and/or software in accordance with embodiments of the present invention.

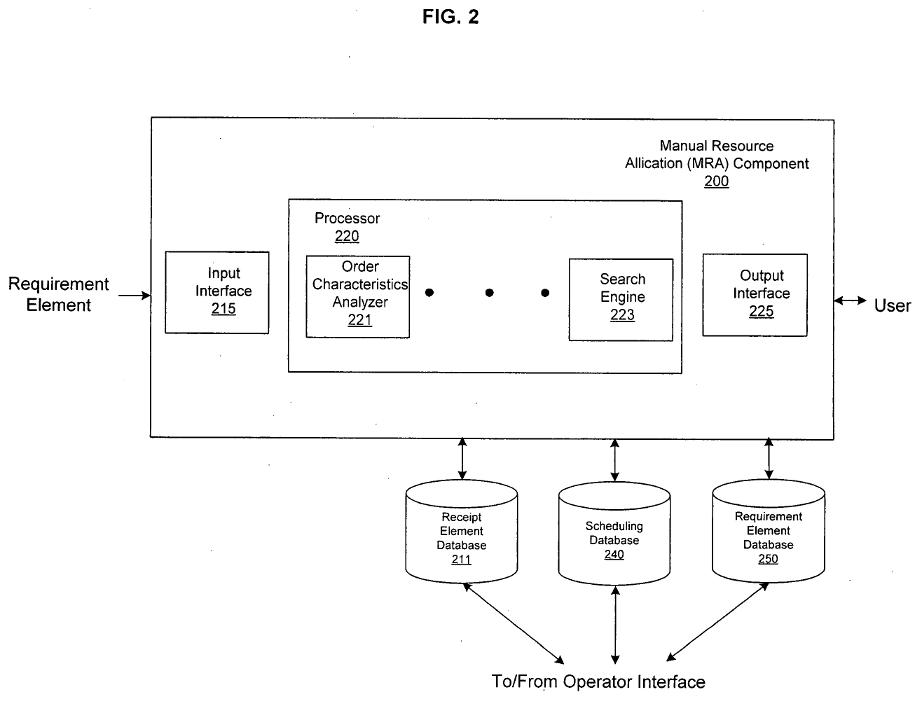

FIG. 2 is a block diagram of an MRA system component 200 that may be used to process customer orders in accordance with an embodiment of the present invention. MRA component 200 may be used to implement the MRA process described with respect to FIG. 1 and/or any other any other type order processing system or device. The MRA component 200 may include, for example, an input interface 215, processor 220 and/or output interface 225. In embodiments of the present invention, the output interface 225 may include a display, a speaker and/or any other type of output interface known. The output interface 225 and/or input interface 215 may provide an graphical user interface for transmitting and/or receiving information related to the manual resource assignment system, in accordance with embodiments of the present invention. The input interface 215 may include any type of input device such as keyboard, mouse, and/or any other type of input interface. It is recognized that the MRA component 200 may include additional components that have been omitted for simplicity. The MRA component 200 may be coupled with one or more databases such as inventory database 270, receipt element database 211, scheduling database 240, requirement element database 250 and/or any other database.

It is recognized that embodiments of the present invention may be processed using a personal digital assistant (PDA), a PC, a computer network, mainframe, and/or another type of electronic device or the like.

One or more requirement elements may be received at the MRA system component 200 via interface 215. The order analyzer 221 may analyze the characteristics of the requirement element and/or other criteria associated with the order to determine which products and/or services are desired. For example, the characteristics of the requirement elements may include the name or identity of the product, the desired quantity, quality, delivery dates, and/or any other information related to the order and/or the requested product. The analyzer may retrieve such information and this information may be used by the search engine 223 to find receipt elements that may be used to complete or fulfill the pending order or orders. As indicated above, a receipt element may be defined as an element of an order that represents the availability date, the quantity of a product that is provided by the order. Receipt elements may be items in stock, items planned for production, items purchased from a third party and/or any other item that may be used to complete the sales order or the customer's order.

In embodiments of the present invention, the search engine 223 may search receipt element database 211, scheduling database, and/or any other database for one or more receipt elements that can be used to complete the received order represented by the requirement element. For example, the search engine 223 may search the receipt element database 211, and/or any other database for products or receipt elements that have characteristic value assignments that match the characteristic value assignments associated with the one or more requirement elements. The receipt element database 211 may include inventory items, planned production items, purchased or planned purchased items, etc. The purchased or planned purchased items may include products purchased or planned to be purchased from another party. The various databases such as databases 211, 240, 250, etc. may be incorporated into a single database and/or may exist as separate databases. These databases may be incorporated internal to the MRA system 120 and/or MRA component 200 and/or may be located external to these systems/components.

In embodiments of the present invention, other characteristics that may be considered when searching for receipt elements may include, for example, location of the product, account assignment, planning version, etc. By comparing the value assignments of the receipt elements with requirement criteria of the product required, the MRA component 200 may identify the receipt elements that can be used to complete the order.

In embodiments of the present invention, the MRA component 200 may include other factors such availability of resources to complete the order, quantity of off-cuts (e.g., leftover material) and or other information.

If the MRA component 200 is unable to find a receipt element match for the requirement element or if the user is otherwise unsatisfied with the identified receipt elements, the MRA component may present a MRA dialog via, for, example interface 225. The MRA dialog may permit the user to modify the requirement element or the demand so that another search can be conducted to complete the modified demand. The modification to the requirement element may be based on the existing receipt elements, personal insight of the user, characteristics of the material required, available substitutes and/or any other information. The modified search may provide another list of one or more receipt elements that may be used to complete the customer's order. The user may select one or more entries in the list to complete at least a portion of the demand. The user may engage in a further MRA dialog to identify additional receipt element(s) that may be used to fulfill the demand.

In embodiments of the present invention, as the user selects one or more receipt elements to complete the demand, one or more off-cuts may be generated from the selected receipt elements, in accordance with embodiments of the present invention. An off-cut may be leftover or surplus material or products that may result from the receipt elements that are used to complete the demand. In embodiments of the present invention, the off-cuts may be returned to stock, to planned production, sold to third party and/or otherwise be used to complete orders. In accordance embodiments of the present invention, orders for the one or more receipt elements and/or orders for the identified of-cuts may be generated by the MRA component 200.

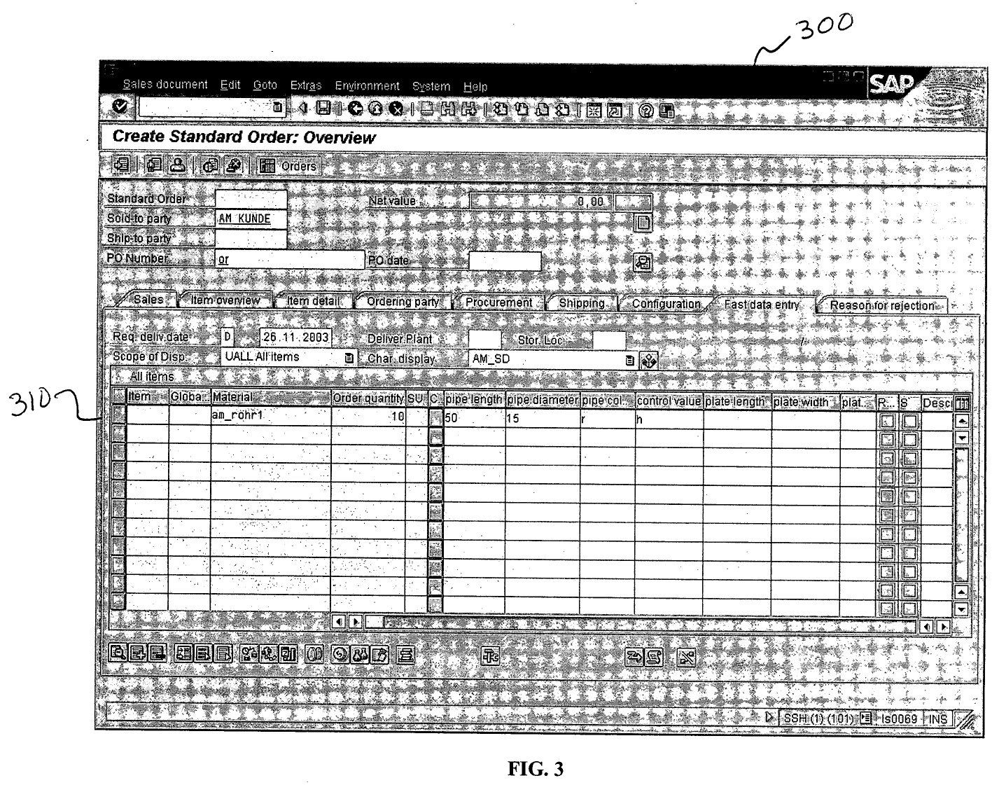

FIG. 3 is a screen snapshot 300 of an interface that may be provided by an MRA system, in accordance with an embodiment of the invention. The screen snapshot 300 may be a sales order interface that a user may utilize to input sales order for processing in accordance with embodiments of the present invention. As shown by entry 310, the characteristic values of the requirement elements may be input via the sales order input screen 300. As shown, the characteristics may include, for example, material name, order quantity, and other characteristics such length, diameter, color, etc. It is recognized that each requirement will have its own values and that the values shown in entry 310 are given by example only. The data input via interface 300 may be used to do an ATP (available-to-promise) check in accordance with embodiments of the present invention. The MRA system search appropriate databases for one or more receipt elements that be used to complete the order for the requirement element or demand. The system may create a planned production order including one or more of the identified receipt elements.

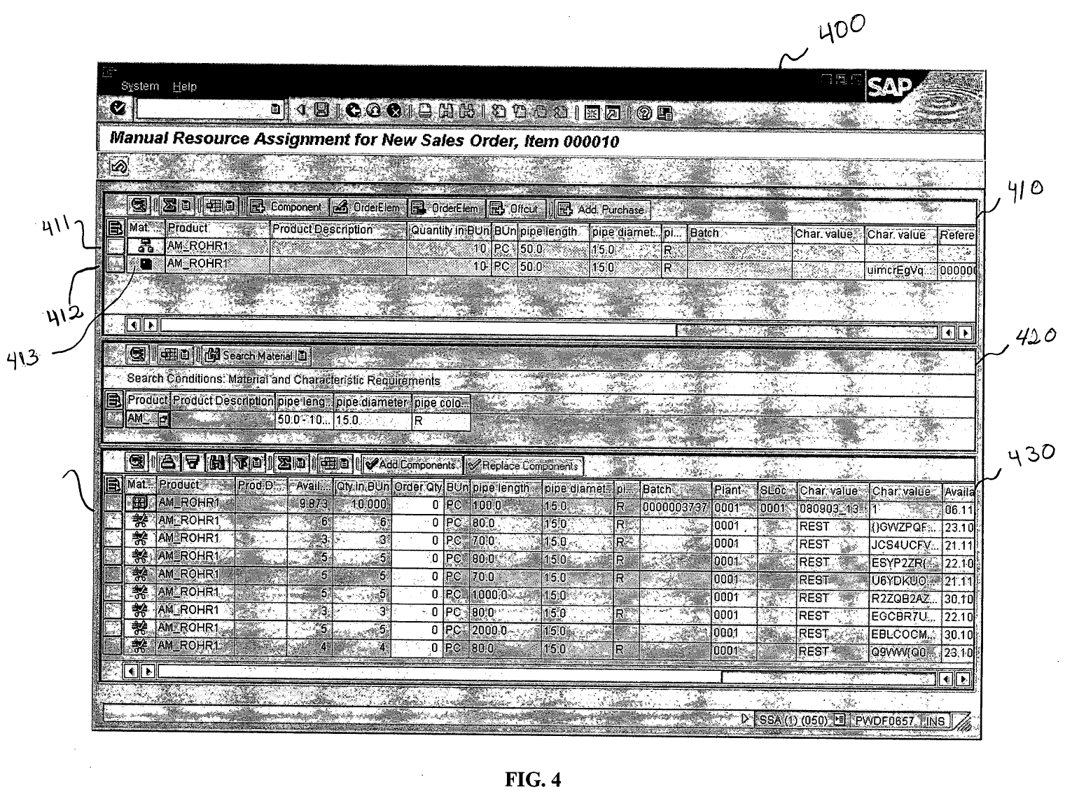

In embodiments of the present invention, if one or more receipt elements to meet the demand are not identified and/or if the user is unsatisfied with the identified one or more receipt elements, an MRA dialog interface 400 may be presented to the user, as shown in FIG. 4. Section 410 may include several entries related to the sales order and/or the results of the ATP check. For example, section 410 may include entry 411 that identifies the production order or the output receipt. Section 410 may also include entry 412 that identifies the requirement element or demand that is needed. It is recognized that section 410 may include additional entries. Icon or symbol 413 associated with entry 412 may indicate that a suitable match for the requirement element was not found and/or that the requirement element may need to be modified so that one or more desirable receipt elements may be identified. Section 420 of interface 400 may permit the user to make manual modifications to the value characteristics associated with the requirement element. For example, section 420 may permit the user to change the parameters associated with the demand. Section 430 may include a list of all receipt elements (e.g., search results) that may be identified as a result of the ATP check. Based on the receipt elements identified in section 430, the system and/or the user may indicate that the value characteristics associated with the requirement elements should be modified.

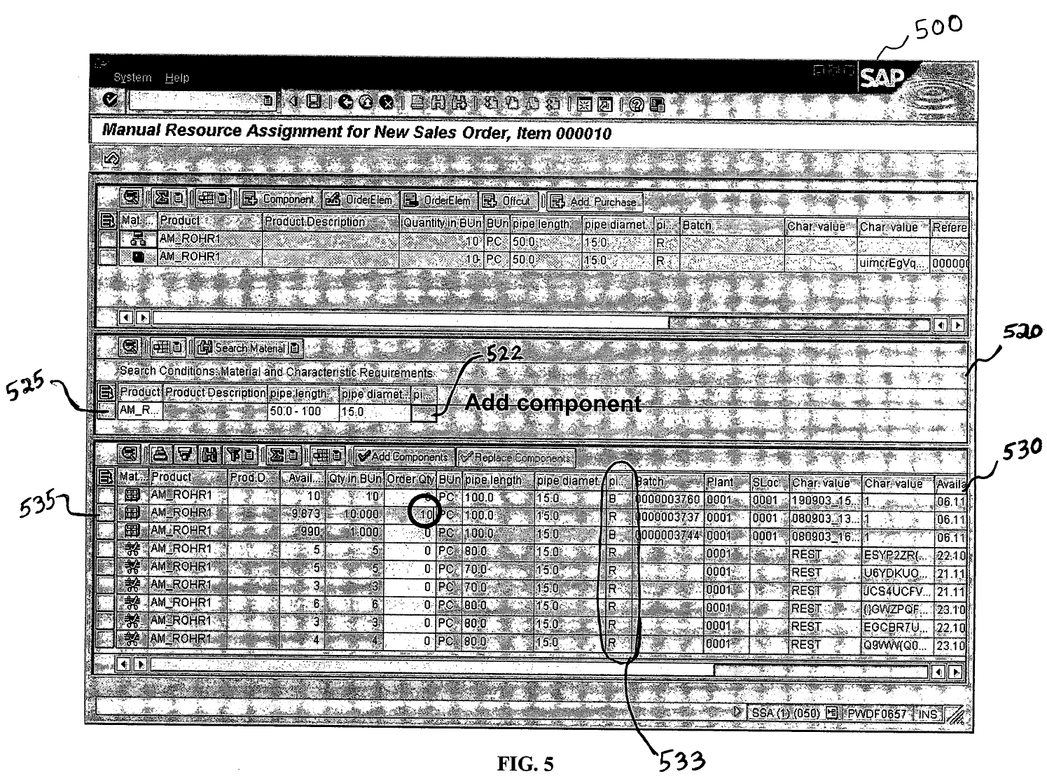

As shown in section 520 of display 500 of FIG. 5, the user may modify the requirement element by changing, for example, the color value 522 associated with the requirement element, in accordance with embodiments of the preset invention. In this case the user may remove the color value and may wish to identify receipt elements of any color. It is recognized that the user can choose to change or modify any characteristic value associated with the requirement element. Another search may be conducted based on the modified requirement element identified by entry 525. The results of the search based on the modified requirement element may be shown in section 530. Section 530 may include a list of the all of the receipt elements identified based on the modified search. As shown, the list 530 may include identified receipt elements of assorted colors 533. Based on the modified search, the user may select entry 535 in section 530 as a receipt element that may be used to fulfill the demand. It is recognized that the user can identify additional receipt elements from section 530 that may be used to fulfill the demand, in accordance with embodiments of the present invention. Moreover, it is further recognized that the user may make additional modifications to the requirement element 525 shown in section 520. Additional searches may be performed based on the modified requirement element.

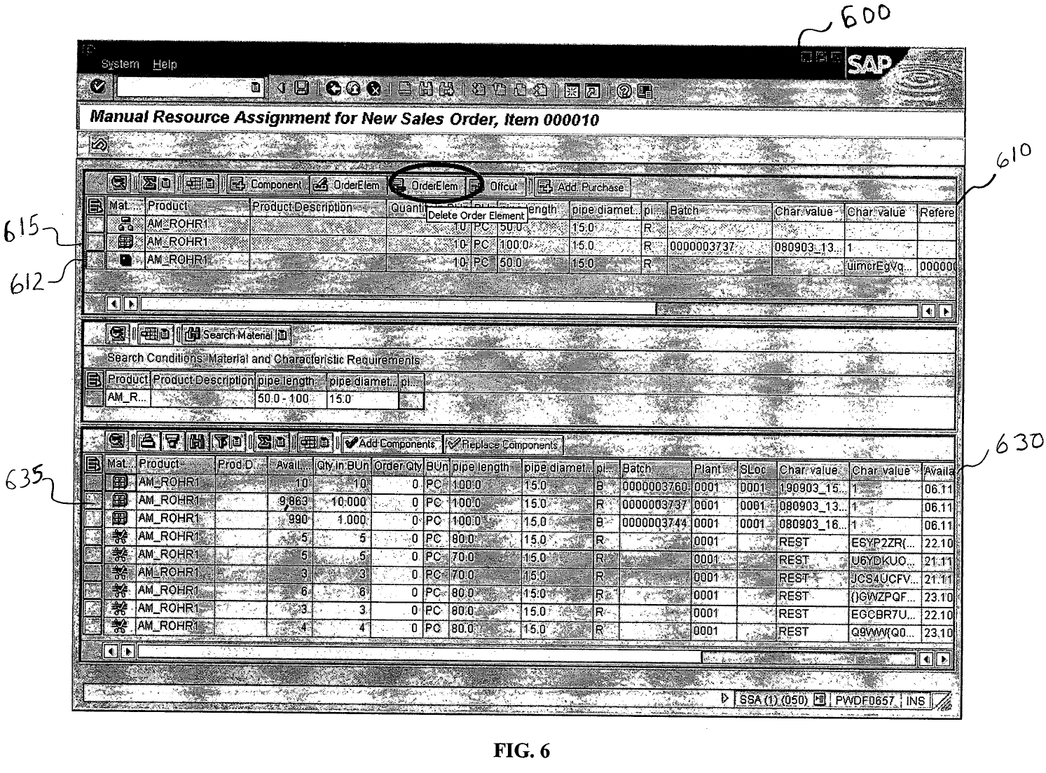

In accordance with embodiments of the present invention, FIG. 6 shows a new sales order 600 that may be generated based on the requirement element identified in entry 535 selected by the user. As shown in section 610, entry 615 may be the new demand or input based on entry 535 and entry 612 which was the original demand (e.g., entry 412 shown in FIG. 4) may be manually deleted by the user. Section 630 shows the receipt element 635 that may remain after desired quantity is selected to fulfill the requirement element, as identified by entry 615.

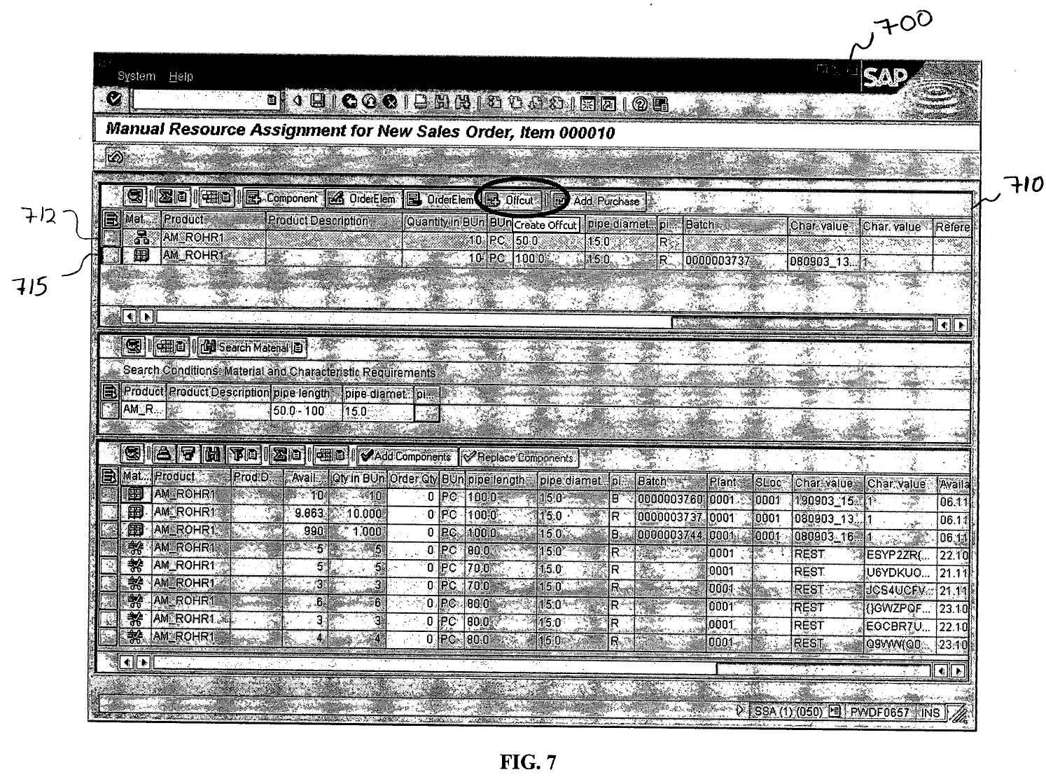

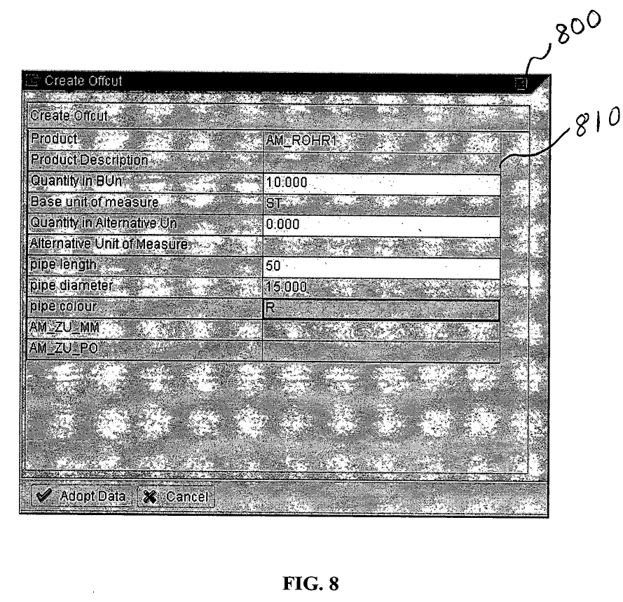

In accordance with embodiments of the present invention, interface 700 shown in FIG. 7 may be used to generate an off-cut from the selected receipt element. As shown in section 710, in this example, the length needed by the requirement element is 50 units (entry 712) and the length available with the selected receipt element (entry 715) is 100 units. Thus, in this example, an off-cut of approximately 50 units is generated by selection of “Off-cut” button shown in section 710. FIG. 8 shows an off-cut order 800 that may be generated in accordance with embodiments of the present invention. As shown in FIG. 8, section 810 may include characteristic values associated with the generated off-cut. As indicated above, the off-cut may be returned to stock, to planned production stock, sold to third party and/or otherwise be used to complete orders.

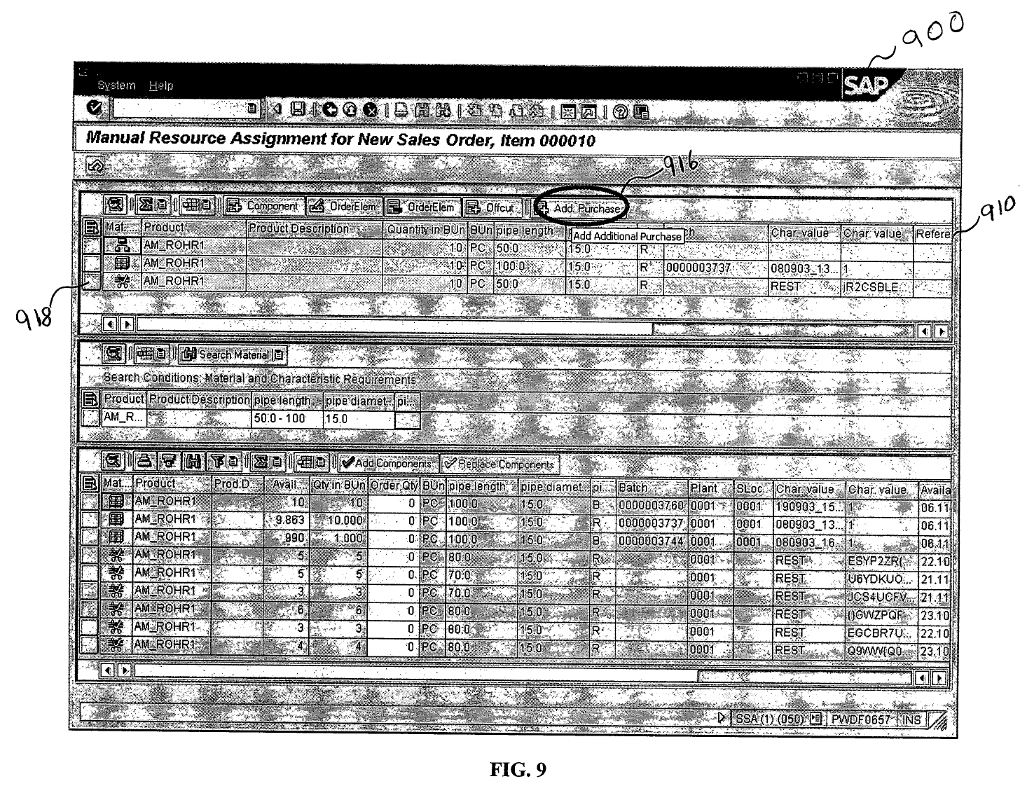

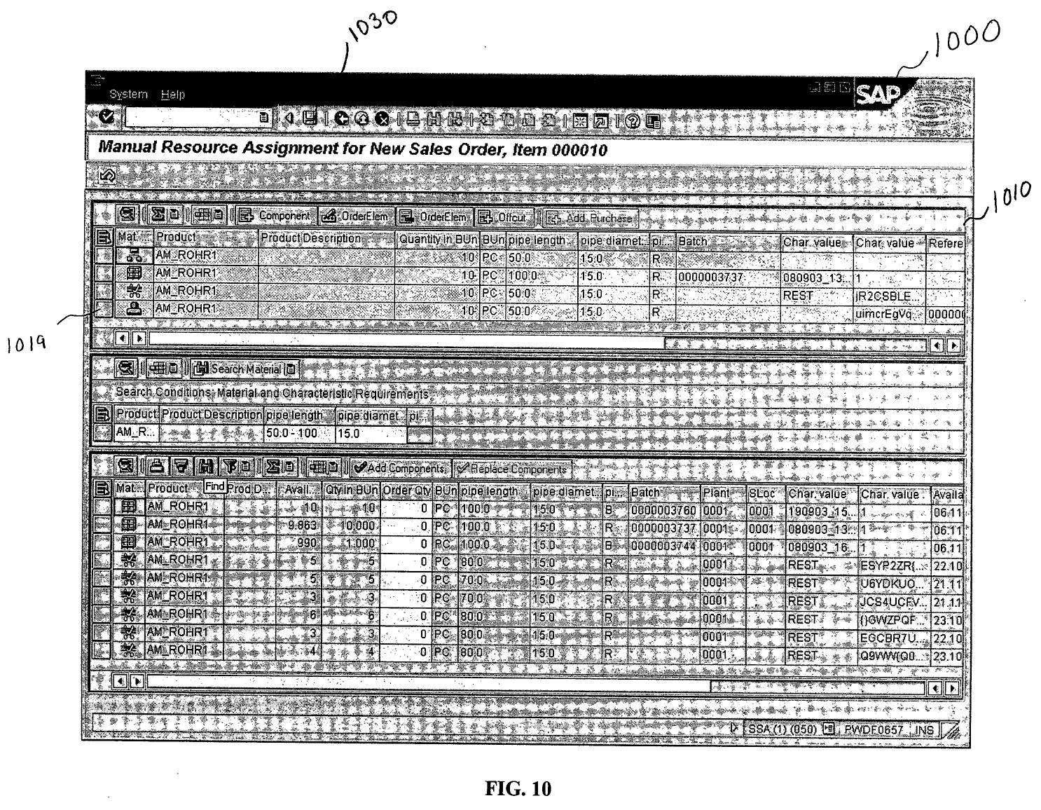

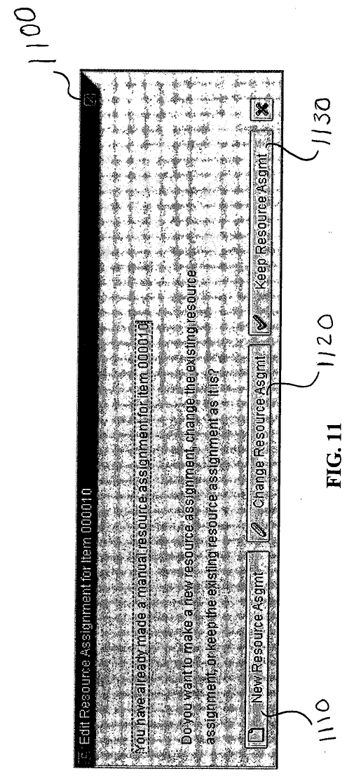

As shown in FIG. 9, interface 900 includes the newly created off-cut entry 918. The user may generate an additional purchase order by selecting button 916, as shown in interface 900. FIG. 10 shows section 1010 including new purchase order represented by entry 1019. The new purchase order may be used to complete the demand in the event a receipt element can not be identified. Once the user is satisfied with the modified sales order, the user may return to the sales order interface 300, for example, by selecting button 1030. The user can update or edit the sales order using interface 1100 shown in FIG. 11. If the user selects button 1110, the user may generate a new search interface 500 shown in FIG. 5. However, if the user wishes to change the current order, the user may select button 1120 and the user may return to interface 1000, where the user can modify the existing order. If the user wishes to keep the current order and/or make minor modifications, the user may select button 1130.

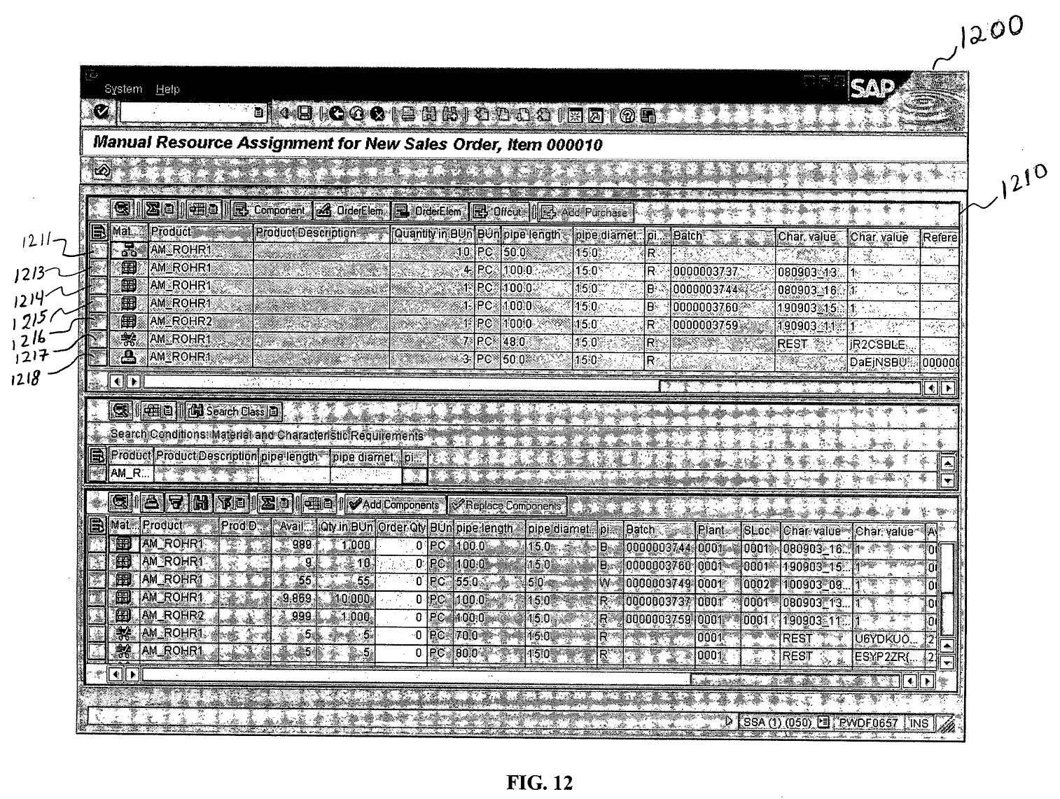

FIG. 12 shows a sales order 1200 that may be generated by an MRA system in accordance with an embodiment of the present invention. Section 1210 may include a plurality of entries including entry 1211 which may represent the output that is needed to complete the order. Entries 1213, 1214, 1215 and 1216 may represent the input that may be generated after various iterations using an MRA technique, as described herein. It can be seen that in the “quantity” column of entries 1213-1216 only 7 units of the item appears to be available from planned production. The remaining 3 units may be purchased from another source as indicated by entry 1218. Moreover, as indicated by entry 1217, off-cuts may be generated in accordance with embodiments of the present invention.

It is recognized that the MRA process as described herein and as shown in the figures can have myriad applications. For example, the MRA system and/or technique can be used in providing paper, textile, steel, cables, lumber, metal sheets, metal blocks, pipes etc. Thus, the MRA process can be applied or used when processing orders for any type of products and/or material.

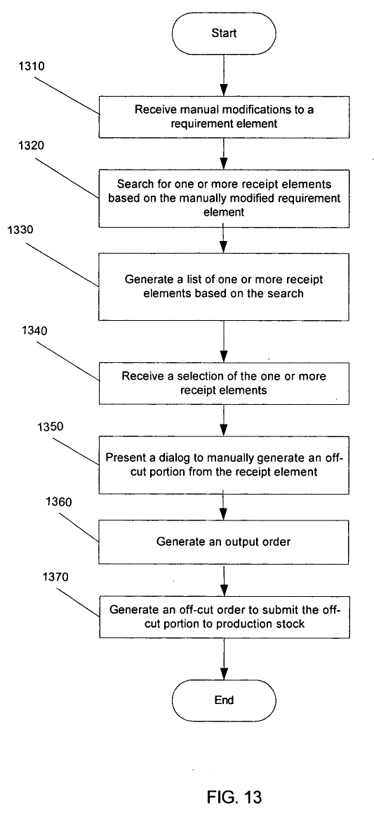

FIG. 13 is a flow chart illustrating a method in accordance with an embodiment of the present invention. A user may complete a sales order including one or more requirement elements. A search may be conducted for the one or more receipt elements based on the requirement element. If a match is not found and/or if the user desires to implement a manual resource assignment process, manual modifications to the requirement element may be received, as shown in box 1310. A search for one or more receipt elements may be conducted based on the manually modified requirement element, as shown in box 1320. As shown in box 1330, a list of one or more receipt elements may be generated based on the search. A selection of the one or more receipt elements may be received, as shown in box 1340. A dialog to manually generate an off-cut portion from the receipt element may be presented, as shown in box 1350. An output order may be generated, as shown in box 1360. The output order may be generated by deducting the off-cut portion from the selected one or more receipt elements. As shown in box 1370, an off-cut order may be generated to submit the off-cut portion to production stock.

It is recognized that embodiments of the present invention may be processed in a standalone and/or network computer. For example, the MRA system 120 and/or MRA component 200 may be incorporated in and/or implemented using a standalone computer and/or a computer network. It is recognized that the various databases as described herein may be located in any type of data storage device or memory. These storage memories may be located internal to and/or internal to these computers. Appropriate communications networks, interfaces and/or other hardware may be included in the MRA system described herein, in accordance with embodiments of the present invention.

It is recognized that a computer or other processing device on which embodiments of the present invention may be processed, may contain the appropriate software and/or hardware (e.g., one or more processors, I/O devices, etc) to carry out the functionality as described herein. Appropriate fields in the various databases described herein may be searched for product related information. A program or macro may be created that may specify the fields to search based on the type of information required.

Several embodiments of the present invention are specifically illustrated and described herein. However, it will be appreciated that modifications and variations of the present invention are covered by the above teachings and within the purview of the appended claims without departing from the spirit and intended scope of the invention.

1. A method for manual resource assignment, comprising:
receiving manual modifications to a requirement element;
searching for one or more receipt elements based on the manually modified requirement element;
generating a list of one or more receipt elements based on the search;
receiving a selection of the one or more receipt elements;
presenting a dialog to manually generate an off-cut portion from the receipt element;
generating an output order, wherein the output order is generated by deducting the off-cut portion from the selected one or more receipt elements; and
generating an off-cut order to submit the off-cut portion to production stock.

2. The method of claim 1, wherein the one or more receipt elements are one or more existing receipt elements.

3. The method of claim 1, wherein the one or more receipt elements are one or more receipt elements planned for production.

4. The method of claim 1, wherein the one or more receipt elements are one or more receipt elements purchased from a third party.

5. The method of claim 1, wherein manual modifications to the requirement element are received if a match for the requirement element is not found.

6. The method of claim 1, further comprising:
receiving a sales order including the requirement element.

7. The method of claim 6, wherein the sales order is for metal products.

8. The method of claim 6, wherein the sales order is for wood products.

9. The method of claim 6, wherein the sales order is for fabric products.

10. The method of claim 6, wherein the sales order is for fabric products.

11. The method of claim 1, further comprising:
searching for one or more receipt elements that are multiples of the sales order, wherein the one or more receipt elements that are multiples of the sales order are included in the list.

12. The method of claim 1, further comprising:
comparing one or more characteristics values associated With the requirement element with one or more characteristic values associated with the one or more receipt elements.

13. Apparatus comprising:
a manual resource assignment interface to receive manual modifications to a requirement element;
a search engine to search for one or more receipt elements based on the manually modified requirement element;
an output interface to present a list of one or more receipt elements based on the search, wherein the manual resource assignment interface is to receive a selection of the one or more receipt elements and the output interface is to present a dialog to manually generate an off-cut portion from the receipt element and to generate an output order, wherein the output order is generated by deducting the off-cut portion from the selected one or more receipt elements.

14. The apparatus of claim 13, further comprising:
a receipt element database, wherein the search engine is to search the receipt element database for the one or more receipt elements.

15. The apparatus of claim 13, wherein the manual resource interface is to generate an off-cut order to submit the off-cut portion to production stock.

16. A method for manual resource assignment, comprising:
searching for one or more receipt elements based on a received requirement;
presenting a manual resource assignment interface to a user, if a match based on a predetermined criteria is not found;
receiving manual modifications to one or more characteristics associated with the requirement element via the manual resource assignment interface;
searching for one or more additional receipt elements based on the manual modifications; and
presenting a list including one or more additional receipt element based on the search.

17. The method of claim 16, further comprising:
receiving a selection of one or more elements from the list;
generating a requirement order based on the received selection, wherein the requirement order includes a modified requirement and an off-cut order.

18. The method of claim 17, wherein the off-cut order is generated by deducting the modified requirement from the one or more elements selected from the list.

19. The method of claim 17, further comprising:
forwarding the off-cut order to a production stock order.

20. The method of claim 16, wherein the received requirement is related to metal products.

21. The method of claim 16, wherein the received requirement is related to wood products.

22. The method of claim 16, wherein the received requirement is related to fabric products.

23. The method of claim 16, wherein the received requirement is related to fabric products.
